(19) United States
(12) Patent Application Publication
(10) Pub. No.: US 2010/0235366 A1
(43) Pub. Date: Sep. 16, 2010

(54) DATA FILE AGGREGATION WITH RESPECT TO USER SPECIFIC TEMPORAL RANGE

(75) Inventors: Felix Gerard Tarquil Ifor Andrew, Seattle, WA (US); Philip Lawrence William Hayward, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/403,954

(22) Filed: Mar. 13, 2009

(51) Int. Cl. G06F 7/00; G06F 3/048

(52) U.S. Cl. 707/752; 715/700; 707/E17.01; 707/E17.009; 707/E17.018; 701/300

(57) ABSTRACT

A method and system of file aggregation is provided herein. Input is received in the form of a user specific temporal range, and is compared to a value within a temporal metadata field of a data file to determine an appropriate data set within which to compile the data file for presentation. In this way, data files within a particular data set may be selectively presented to a user. For example, if a user begins taking photos at 11 p.m. and continues until 2 a.m. the next day, the user may specify the photos taken between 11 p.m. and 2 a.m. are to be compiled into a single data set for presentation, as opposed to presenting the photos in data sets corresponding to different days.

### BACKGROUND

Within a computing environment, data may be segmented or broken up into a variety of different blocks, commonly referred to as data files. These data files may be aggregated in a variety of different manners, typically by consulting metadata comprised within, embedded within and/or otherwise associated with the respective data files. Metadata generally comprises ancillary data indicative of one or more attributes of a data file. For example, where a data file corresponds to a digital image, the metadata for that data file may comprise, among other things, the date the digital image was acquired. Accordingly, the digital image may be compiled into a particular data set based upon the date the image was acquired.

While some techniques exist for automatically aggregating data files based upon associated metadata, these techniques generally do not take into account particular user preferences for compiling the data files into appropriate data set(s) for presentation, at least with regard to a temporal aspect. Consequently, even where data files may be somewhat auto-organized and subsequently presented in a data set, the data set may not reflect the desired temporal preference of the user, thus needing further refinement. While seemingly trivial, this is becoming a greater concern as individuals are continually amassing greater and greater amounts of digital data to manage.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A technique for aggregating a data file according to a user specific temporal range is disclosed herein. Aggregating the data file in this manner allows the data file to be automatically compiled into an appropriate data set based upon the user's temporal preference. This mitigates the need for manual compilation of the data file into the appropriate data set for presentation, at least with regard to satisfying the user's temporal preference.

To accomplish the aggregating, the user's temporal preference (e.g., in the form of a temporal range) is received, and a value within a temporal metadata field of the data file is compared with this user specific temporal range to determine an appropriate data set within which to compile the data file (e.g., for ultimate presentation to a user). It will be appreciated that metadata is often arranged or formatted into one or more fields. Accordingly, the metadata field (and more particularly the value therein) that is relevant to the disclosure herein relates to a temporal attribute of the data file. It will be appreciated that more than one metadata field may relate to a temporal attribute of a data file. For example, a first metadata field may comprise a value relating to a time the data file was created, a second metadata field may comprise a value relating to a date the data file was modified, etc. Similarly, a single metadata field (e.g., a creation time and date metadata field) may comprise a value relating to both the time and the date that the data file was created. It will be appreciated that any one or more of such metadata fields may be consulted in accordance with the disclosure herein.

The aggregating described herein may have particular relevance to situations where the data file corresponds to a digital image, for example, and where the data file is created (e.g., digital picture is taken) just before or after a predefined temporal event transpires, which may overlap the common notion of a 24 hour day. For example, if a digital image has a timestamp (e.g., one or more temporal metadata values indicative) of 12:01 am on January 1^{st}, then this image was likely acquired during a New Year's Eve celebration. Accordingly, as provided herein the digital image may be automatically compiled into a data set named December 31^{st}, instead of a data set corresponding to January 1^{st}. That is, the user may predefine the temporal range to extend until 5:00 am, for example, on January 1^{st} so that any images taken up to then are automatically compiled into a data set corresponding to December 31^{st} (e.g., New Year's Eve party) folder, but any image acquired on or after 5:01 am on January 1^{st} are instead stored in the January 1^{st} (e.g., New Year's Day dinner) for presentation. It will be appreciated that this is merely just one example and that the user defined temporal range can span any time period (e.g., partial days, multiple days, etc.).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1A is an illustration of presenting one or more data file organized into one or more data sets.

FIG. 1B is a flow chart illustrating an exemplary method of aggregating a data file with respect to a user specific temporal range.

FIG. 2 is a component block diagram illustrating an exemplary system for aggregating a data file with respect to a user specific temporal range.

FIG. 3 is an illustration of aggregating one or more data files with respect to a user specific temporal range.

FIG. 4 is an illustration of a user affirming an aggregation of data files with respect to a user specific temporal range.

FIG. 5 is an illustration of aggregating one or more data files with respect to a user specific temporal range.

FIG. 6 is an illustration of aggregating one or more data files with respect to a user specific temporal range.

FIG. 7 is an illustration of a user specific temporal range derived from a user specific calendar component.

FIG. 8 is an illustration of an exemplary computer-readable medium comprising processor-executable instructions configured to embody one or more of the provisions set forth herein.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Many computing scenarios involve compiling and presenting data files. For example, a catalog of multimedia on a computing system and/or remote source may comprise thousands of data files (e.g., songs, digital images, video clips), which may be presented to a user. Traditional methods and systems compile these data files by metadata parameters such as date, time, artist, location, etc. This traditional compiling falls short, however, by not allowing further user specification of these parameters, such as temporal ranges of the data files.

Accordingly, among other things, a technique for aggregating one or more data files with respect to a user specific temporal range is provided herein.

It may be appreciated that compiling data files into a data set as provided herein may be broadly interpreted to comprise not only organizing data files together, but also as establishing a correlation (e.g., a mapping to one or more data files based upon a user specific temporal range) among one or more data files, which may be located separate from one another, for the purpose of presenting the data files within the data set to a user. That is, data files compiled into the data set may retain their original location (e.g., on a local device, remote network storage, a remote communication device, etc.), while the data set describes a particular correlation between the compiled data files within the data set. For example, image files may be compiled into a data set by searching for image files from remote and/or local sources, wherein the compiled image files correspond to (e.g., fall within) the user specific temporal range. The data set may describe the correlation of the compiled image files, while retaining the original location of the image files. The image files within the data set may be selectively presented through a web page, a user interface, a window, etc. based upon the correlation (e.g., mapping) described by the data set.

It will be appreciated that a data set, as used herein, is intended to comprise not just locally compiled data files, but also collections of data files across remote devices, network platforms, the internet, etc. That is, application of the disclosure herein is not limited to a local device, but has broader application to the internet, networked devices/environments, web services, etc. For example, a data file, as used herein may comprise a thumbnail image depicted on a web page, an image presented in an album via a secure web-site, such as a social network and/or an online image sharing application, etc.

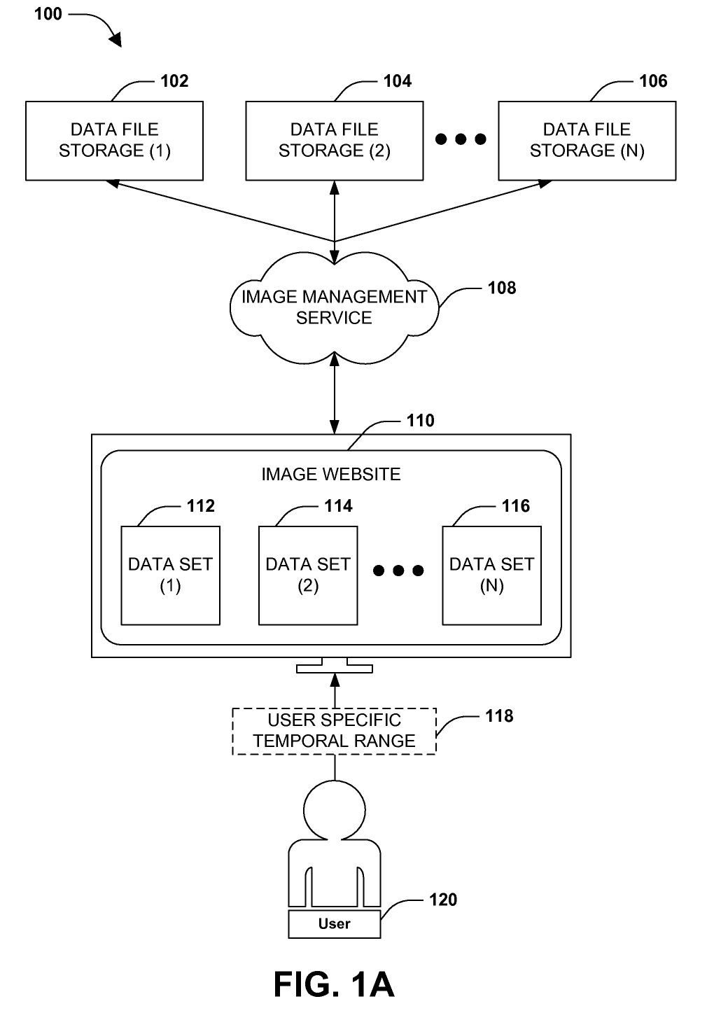

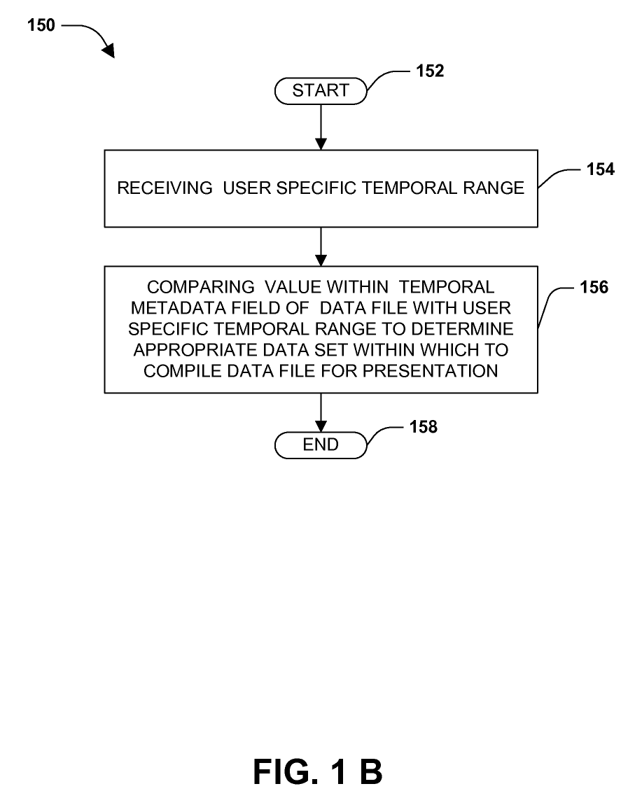

FIG. 1A is an illustration of a manner of presenting one or more data files compiled into one or more data sets as provided herein. An image website 110 may be configured to allow users (e.g., a user 120) to upload, organize, and share data files (e.g., image data files) with other users. It may be appreciated that although the illustrated example is discussed in the context of a website, that the disclosure herein it not so limited. For example, it may operate through a network service, an application on a mobile device, and/or other techniques running locally and/or remotely.

The image website 110 may be configured to receive a user specific temporal range 118 from the user 120. In one example, the user specific temporal range 118 may specify a “user defined day” comprising a beginning time and an ending time (e.g., for purposes of compiling and presenting image data files, it may be beneficial to start the user's day at 1:00 pm and end a user's day at 3:00 am if the user tends to take pictures, for example from a wedding, from 1:00 pm to 2:30 am the next day). The image website 110 may utilize the user specific temporal range 118 to determine an appropriate data set into which a data file may be compiled (e.g., for ultimate presentation to a user). For example, image data files of the user 120 may be stored within a data file storage (1) 102, a data file storage (2) 104, and/or other data file storages (e.g., a data file storage (N) 106). It may be appreciated that the image data files may be compiled into a data set, wherein the data set describes a correlation between the data files without moving the data files from their respective data storages. It may be appreciated that the data file storages may be located locally and/or remotely (e.g., on a network data warehouse).

It may be beneficial to aggregate the image data files based upon the user specific temporal range 118 (e.g., the “user defined day”). In one example, the image website 110 may receive a user specific temporal range 118 designating a beginning time from 1:00 pm to an ending time 3:00 am. As a result, one or more data sets may be defined based upon the user specific temporal range 118 (e.g., creating one or more data sets spanning the “user defined day” 1:00 pm to 3:00 am). The image website 110 may utilize an image management service 108, for example, to compare values within temporal metadata fields of data files stored within the data file storages with the user specific temporal range 118 to determine an appropriate data set into which one or more data files may be compiled. For example, image data files having a value within a temporal metadata field (e.g., creation date/time of an image data file) between March 13^{th} 1:00 pm and March 14^{th} 3:00 am may be complied into a data set (1) 112. Image data files having a value within a temporal metadata field between March 14^{th} 1:00 pm and March 15^{th} 3:00 am may be compiled into a data set (2) 114. Other image data files may be complied into other data sets (e.g., data set (N) 116). The image data files may then be selectively presented to a user as part of the respective data sets (e.g., presented within the image website 110). That is, the images remain stored in their respective data file storage components 102, 104, 106, but may be selectively presented as part of their respective data sets. It will be appreciated that a particular data file may be compiled into more than one data set, and thus may be selectively presented more than once (e.g., the same image may be presented in multiple online photo albums (without actually being removed from its file storage component)).

FIG. 1B illustrates an exemplary method 150 of aggregating a data file with respect to a user specific temporal range. The exemplary method 150 begins at 152. At 154, a user specific temporal range may be received. The user specific temporal range may comprise a beginning time/date and an ending time/date as well as all times/dates there-between, for example. The user specific temporal range may, for example, define a time range that spans a plurality of days or dates or merely a portion thereof. By way of example, the user specific temporal range may comprise a 12 hour time span beginning at 5:00 pm on December 31^{st} and ending at 5:00 am on January 1^{st} to capture events that involve a New Years Eve celebration. It will be appreciated, however, this is merely one example of a user specific temporal range.

At 156, the user specific temporal range may be compared to a value within a temporal metadata field of the data file to determine an appropriate data set within which to compile the data file (e.g., for presentation). It will be appreciated that, depending upon the context of application, this may cause the data file to be compiled (e.g., a mapping may be created correlating one or more data files together based upon the user specific temporal range) within a particular data set, while maintaining the original location of the data file. For example, where the data file comprises a digital image, it may be presented as one of many images within a data set corresponding to a photo album where this data file (as well as other ones “appearing” in the photo album) may or may not actually be stored in the same file folder, but may “appear” to be, when the resulting data set is presented.

It will be appreciated that the metadata associated with the data file may be formatted according to one of many different formats (e.g., exchange image file format (EXFF), extensible metadata format (XMP), information interchange model (IMM), or a variant of the aforementioned, etc.) It will also be appreciated that the user specific temporal range is compared to a value of a temporal metadata field of the data file of a corresponding type. For example, if the user specific temporal range comprises a time range, then it may be compared to a value within a “timestamp” metadata field of the data file. Where the data file comprises a digital image, for example, then the time the digital image was acquired (e.g., picture was taken) may be compared to the user specific temporal range to see if that time falls within the user specific temporal range. If it does, then the image may be compiled into a data set for presentation, wherein the data set may be designating data files that fall within the range (e.g., a file folder labeled New Years Eve celebration). Having compiled the image data into the data file set based upon the user specific temporal range, the method ends at 158.

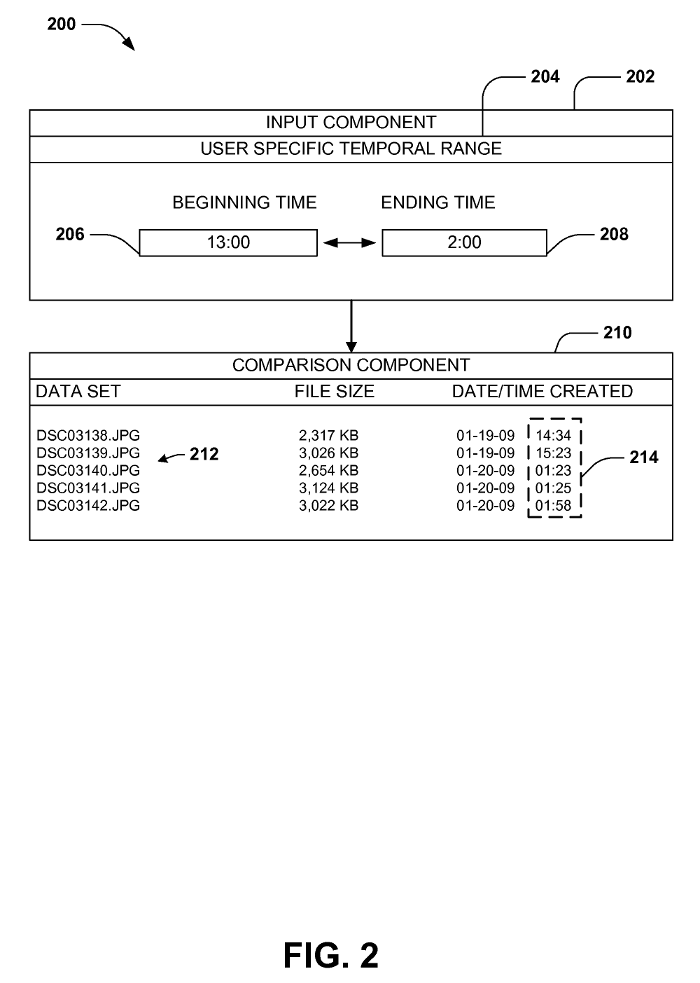

FIG. 2 is a component block diagram illustrating an exemplary system 200 for aggregating a data file with respect to a user specific temporal range. An input component 202 may be configured to receive a user specific temporal range 204 that may be defined by a user (e.g., starting time/date, ending time/date). The input component 202 may be configured to receive input from the user through an input device (e.g., keyboard, mouse, touchpad, etc.) and/or other manners. For, example, the user specific temporal range may be received where a user selects starting and ending dates from a pop-up calendar and/or a calendar that may be part of the user's email application by the user clicking thereon.

The user specific temporal range 204 is generally defined in terms of one or more metadata fields (e.g., creation time/date, modification time/date, last accessed time/date, etc.) of one or more data files that are to be compiled for ultimate presentation. This allows a value within a metadata field of a data file to be compared to the user specific temporal range. For example, the user specific temporal range 204 may comprise a beginning time field 206 and/or an ending time field 208, for example, where the user specific values entered therein define the user specific temporal range. The beginning time and the ending time, for example, may have formatting that is consistent with any of a number of formats, including but not limited to Greenwich Mean Time (GMT) offsets, time zone offsets, Ante Meridiem/Post Meridiem (AM/PM) formatting, 24-hour formatting, etc.

It will be appreciate that the user specific temporal range illustrated in FIG. 2 spans past (the ending of) a typical day. That is, the range begins at 13:00 hours (e.g., 1:00 pm) on a first day and ends at 2:00 hours (e.g., 2:00 am) on a second subsequent day (e.g., spanning past midnight of the first day). Enabling a user to define the range in this manner, thus allows data files that would otherwise be compiled into separate data sets (e.g., one for the first day and one for the second day) to be compiled into a single data set designated for the range.

The system 200 may comprise a comparison component 210 configured to compare a value within a temporal metadata field of a data file to the user specific temporal range 204 (e.g., determine whether the value falls within the user specific temporal range 204, and thus whether the data file may be compiled within a corresponding data set). It will be appreciated that while comparison of “a” value from “a” metadata field is discussed, that one or more respective values from one or more metadata fields from one or more different data files can be compared to the user specific temporal range 204, and then these data files can be “compiled” into appropriate data sets accordingly.

In the example illustrated in FIG. 2, the beginning time field 206 has a user specific value of 13:00 hours (e.g., 1:00 pm) entered therein, while the ending time field 208 has a user specific value of 2:00 hours (e.g., 2:00 am) entered therein. Multiple data files 212 are illustrated in FIG. 2 where the respective times of creation 214 of these different data files fall within the user specific temporal range 204 of between 13:00 hours (e.g., 1:00 pm) and 2:00 hours (e.g., 2:00 am). Accordingly, even though the first two data files were acquired on a first day (e.g., 1-19-09) and the last three data files were acquired on a second subsequent day (e.g., 1-20-09), all of these data files may be compiled into a single data set corresponding to the user specific temporal range because respective creation times of these data files fall within the user specific temporal range. It can be appreciated that allowing the data files to be compiled and/or ultimately presented according to a user specific temporal range provides flexibility heretofore not afforded by conventional means (e.g., where data files having a creation date/time up until midnight would have been compiled into a separate data set corresponding to that day, but where data files having a creation date/time thereafter would be compiled into a data set for subsequent days (instead of into a data set for a previous date as desired by a user)).

By way of example, system 200 may be applicable to searching for data file information from an external file storage device (e.g., a digital camera, a remote computer, an internet device) to be presented on a computing system. For example, the file storage device may include files that span a plurality of days but are intended to be compiled into a single data set. To accomplish this compiling, for example, the user may enter a user specific temporal range that spans a plurality of dates. When the external file storage device is connected with the computing system, values within temporal metadata fields of the data files are compared with the user specific temporal range to determine an appropriate data set within which to compile the data files for presentation. Since the user specific temporal range spans the plurality of dates for the different files, all of the files when presented may appear in a single data set. It will be appreciated that even though the user specific temporal range spans a plurality of dates, the appropriate data set may be named according to a single date, such as the beginning date within the range, for example.

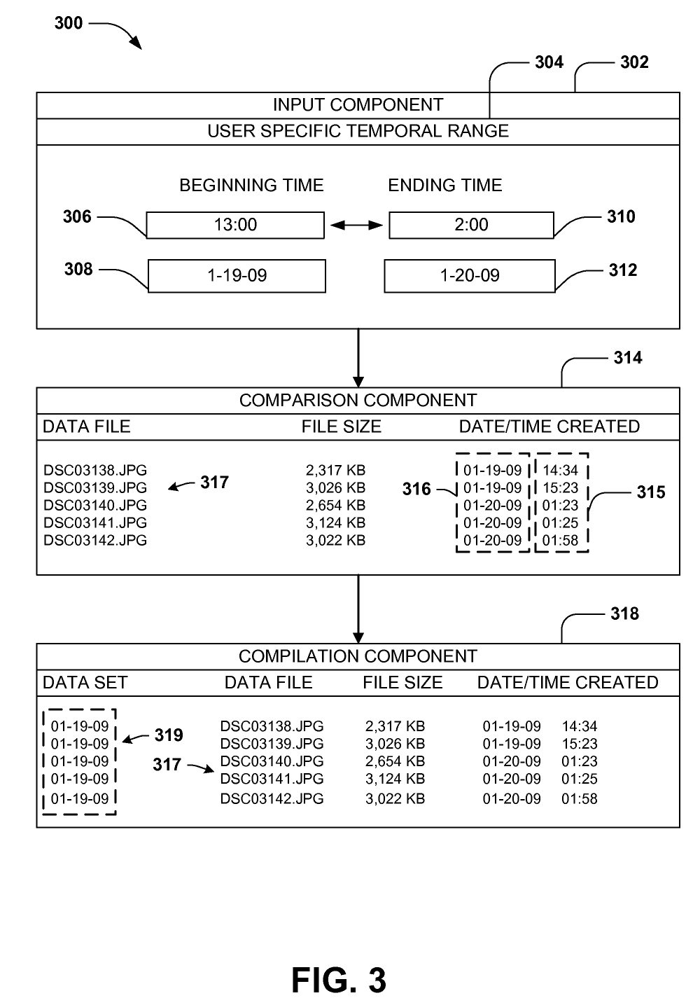

FIG. 3 illustrates a component block diagram of an example 300 of aggregating one or more data files 317 with respect to a user specific temporal range. In this example, an input component 302 may be configured to receive a user specific temporal range 304 comprising a beginning time 306, a beginning date 308, an ending time 310, and/or an ending date 312, for example. A comparison component 314 may be configured to receive the user specific temporal range 304 from the input component 302 and compare a value within a temporal metadata field of a data file with the user specific temporal range to determine an appropriate data set within which to compile the data file. In the illustrated example, the respective times 315 and dates 316 that the data files 317 were created fall within the user specific temporal range 304.

Accordingly, a compilation component 318 may be configured to compile the data files 317 into an appropriate data set 319, wherein the appropriate data set may be named according to a characteristic of the user specific temporal range 304 (e.g., the first value or beginning date of 1-19-09). Placing data files within appropriate data sets according to the user specific temporal range provides a hierarchal organization and naming convention according to the user's preference.

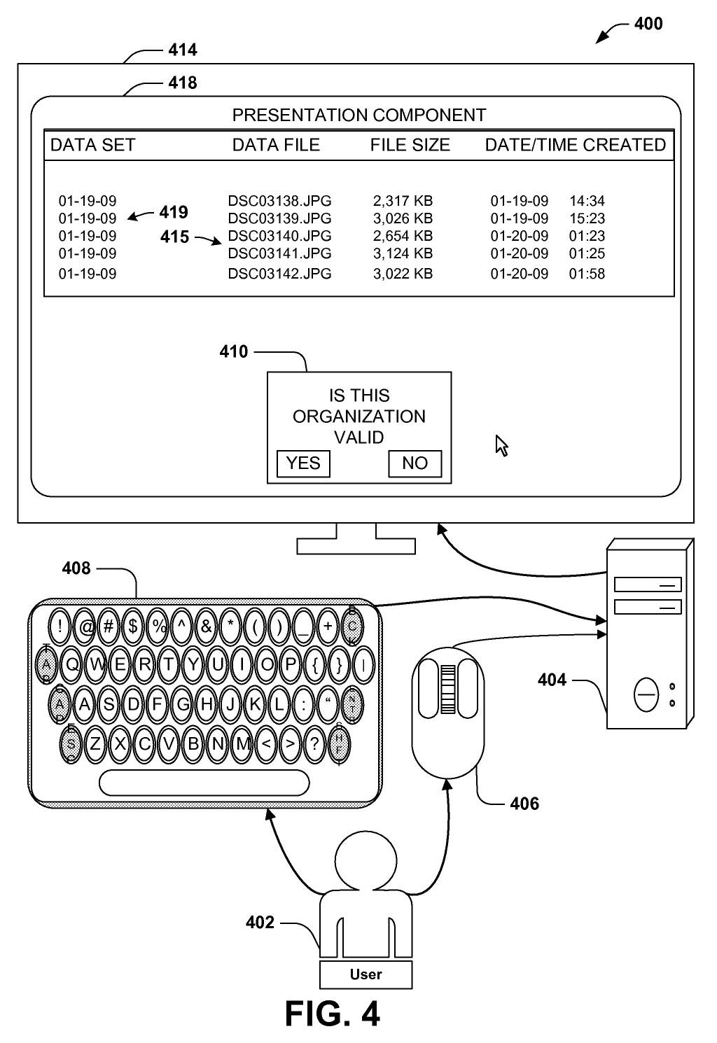

FIG. 4 illustrates an example 400 of a user affirming a compilation of data files 415 with respect to a user specific temporal range (e.g., a user affirmation). A presentation component 418 may be configured to present an affirmation box 410 (e.g., an affirmation component) within a display component 414. The affirmation box 410 may correspond to a “suggested” compilation of data files 415 for compiling into an appropriate data set 419 (e.g., where respective creation times/dates fall within the user specific temporal range).

In one example, input devices (e.g., a keyboard 408 and/or a mouse 406) of a computing system 404 may be used by a user 402 to affirm (e.g., accept) the “suggested” compilation of data files 415 into an appropriate data set 419. Upon receiving the affirmation of the “suggested” compilation, the data files 415 may be compiled into the appropriate data set 419 as affirmed by the user (e.g., an affirmation component may affirm a validity of the data set 419 and a compilation component may recompile the data files according to the user affirmation). In the illustrated example, the data files 415 are compiled into a data set 419 named according to an earliest creation date of the data files (e.g., 1-19-09).

In one example, a camera comprising image files spanning one or more days may be connected to the computing system 404. The image files may be compiled into a suggested data set based upon a user specific temporal range. However, a user may wish to preserve an original organization of the image files. The user may, accordingly, circumvent the compilation of the image files into the suggested data set by disaffirming (e.g., rejecting) the suggested compilation through the affirmation box 410 (e.g., by clicking “NO”).

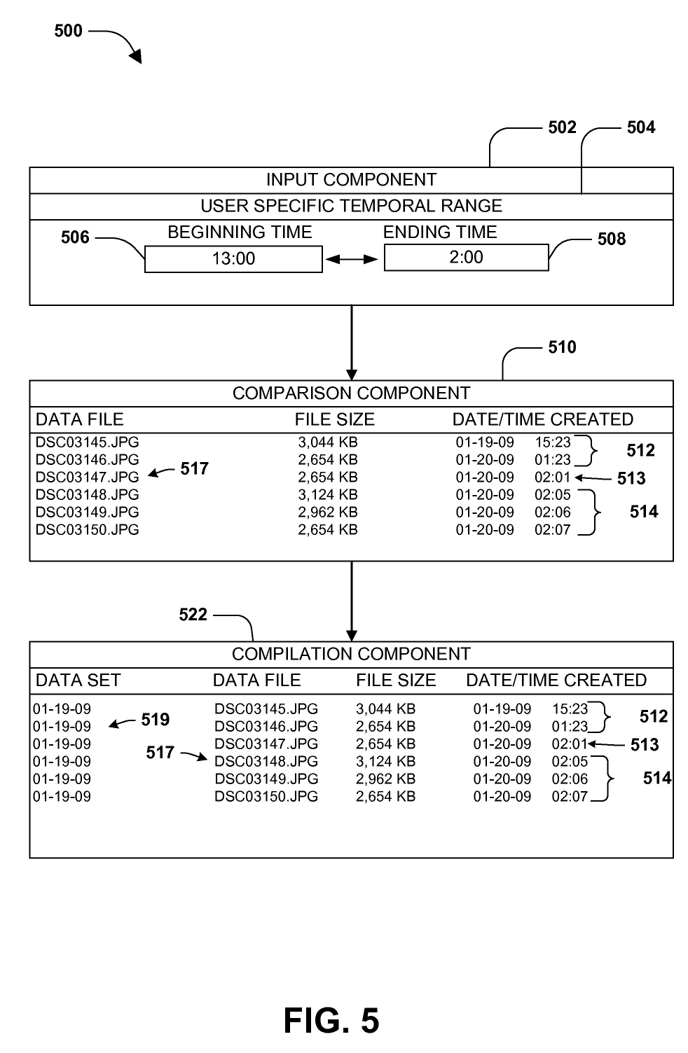

FIG. 5 illustrates a component block diagram of an example 500 of aggregating one or more data files 517 with respect to a user specific temporal range (e.g., into a first data set). In the illustrated example, the user specific temporal range 504 comprises a beginning time 506 (e.g., 13:00 hours) and an ending time 508 (e.g., 2:00 hours). In this example, in addition to falling within the user specific temporal range, the data files 517 are complied into an appropriate data set (e.g., a mapping to particular data files) based upon a proximity to the user specific temporal range and/or a frequency of occurrence within a proximity to the user specific temporal range. For example, if a user specific temporal range ends at 2:00 am, but multiple data files have respective values within a “time acquired” metadata field of between 2:00 am and 2:05 am, then these data files may be compiled into the first data set (e.g., within the same data set as the data files that fall within the user specific 13:00 to 2:00 hour temporal range). The decision to include these “outlier” data files within the first data set may also take into consideration metadata of other data files. For example, if no other data files were acquired until several hours later (e.g., 10:00 am), then that may support the decision to compile the 2:00 am and 2:05 am data files into the first data set (as they were likely acquired during the same event).

Similarly, where the number of “outlier” data files exceeds some predetermined threshold within a certain “outlier period”, then these data files may likewise be compiled within the first data set. For example, where the acquisition times of a few data files are (randomly) scattered outside of the user specific temporal range, then these may not likely be from the same event(s) comprised within the user specific temporal range. Accordingly, these data files would not be stored within the first data set. Where, however, a number of data files are acquired just outside of the user specific temporal range, then this may be indicative of the data files being acquired during the same event(s) comprised within the user specific temporal range. Accordingly, where the number or frequency of data files that fall just outside of (e.g., within a predefined proximity of) the user specific temporal range exceed a predefined threshold (e.g., 10 data files acquired within 5 minutes of the user specific temporal range), then these data files may be stored within the first data set, as they were likely acquired during the event(s) comprised within the user specific temporal range.

In the example illustrated in FIG. 5, an input component 502 may be configured to receive the user specific temporal range 504. A comparison component 510 may be configured to compare the user specific temporal range 504 with a value of a temporal metadata field of a data file to determine an appropriate data set within which to compile the data file. It may be appreciated that a data file having a temporal metadata field value within the user specific temporal range 504, within a proximity of the user specific temporal range, and/or being one of a predefined number of values within a proximity of the user specific temporal range may be compiled within an appropriate data set for presentation.

By way of example, the acquisition dates/times of a couple of data files 512 in FIG. 5 fall within the user specific temporal range (e.g., 15:23 and 1:23 both fall within the range of 13:00 to 2:00). Similarly, the acquisition date/time of another data file 513 is within close proximity of the user specific temporal range (e.g., 2:01 falls just outside of/after the range of 13:00 to 2:00). Also, the acquisition time/date of three other data files 514 indicates that they were acquired within a relatively short period of time close to the user specific temporal range (e.g., DSC03148, DSC03149 and DSC03150 were acquired in quick succession (at 2:05, 2:06 and 2:07, respectively) shortly after the user specific temporal range).

Accordingly, a compilation component 522 may be configured to compile the data files 517 into an appropriate data set 519, wherein the appropriate data set may be named according to a characteristic of the user specific temporal range 504. Compiling data files within appropriate data sets according to the user specific temporal range provides a hierarchal compilation and naming convention according to the user's preference. It will be appreciated that while all of the data files are illustrated as being compiled within the same data set 519 in FIG. 5, that aggregating data files within different data sets may occur. For example, a data file that has a temporal metadata field value outside of the user specific temporal range, not within a proximity of the user specific temporal range, and/or not being one of a predefined number of values within a proximity of the user specific temporal range may be compiled into a default data set (not illustrated), whereas the data files 512, 513 and 514 (that do have a temporal metadata field value within the user specific temporal range, within a proximity of the user specific temporal range, and/or are one of a predefined number of values within a proximity of the user specific temporal range) are compiled within the data set 519.

It will be appreciated that the comparison component 510 and/or compilation component 522 may be configured to determine how close to, or rather how far away from, the user specific temporal range a data file can be, yet still be included within the same data set as those data files that do fall within the user specific temporal range. As alluded to above, this proximity determination may also take into consideration how isolated the data file is relative to other data files. For example, if the data file is just one of a few data files that are randomly scatter about outside of the user specific temporal range (e.g., acquired at 1:23, 2:11 and 2:42 hours outside of the range), then it may instead be filed in a default data set as these data files likely do not correspond to the same event(s) comprised within user specific temporal range.

The comparison component 510 and/or the compilation component 522 may also be configured to determine a sufficient number or threshold of data files (that fall outside of the user specific temporal range) to warrant inclusion within the same data set as those data files that do fall within the user specific temporal range. The proximity of these data files to the user specific temporal range may also be considered in making this determination. For example, the threshold may be lowered where the data files are closer to the user specific temporal range (or increased where the data files are further away from the user specific temporal range). By way of example, where five data files are within a couple of minutes of the user specific temporal range, then these data files may be included within the same data set as those data files that do fall within the user specific temporal range. If, on the other hand, these five data files are ten minutes outside of the user specific temporal range, then they may be compiled into a default folder. Similarly, if the number of data files that are within ten minutes of the user specific temporal range is increased to 25 data files, then these data files may be included within the same data set as those data files that do fall within the user specific temporal range (because it may be more likely that these data files correspond to the same event(s) comprised within the user specific temporal range (e.g., a New Year's Eve celebration)). The determination may, for example, be influenced by user input, a learning algorithm, etc.

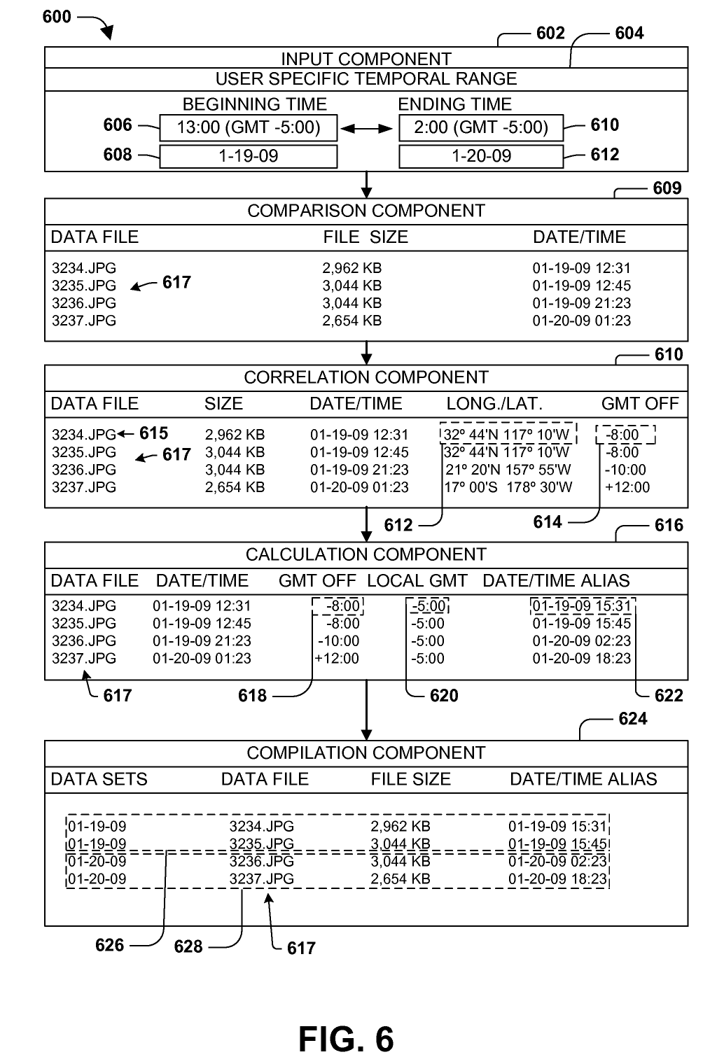

FIG. 6 illustrates a component block diagram of an example 600 of aggregating one or more data files 617 with respect to a user specific temporal range. An input component 602 may be configured to receive a user specific temporal range 604 comprising a beginning time 606, a beginning date 608, an ending time 610, and/or an ending date 612, for example. A comparison component 609 may be configured compare a value within a temporal metadata field of a data file with the user specific temporal range 604 to determine an appropriate data set in which to compile the data file for presenting.

A correlation component 610 may be configured to utilize global positioning system (GPS) metadata of a data file to determine a respective GMT offset for the data file, so that this temporal metadata of the data file is in synch with the user specific temporal range. This effectively allows a data file to be compared to the user specific temporal range, even though the data file was acquired in a different time zone (e.g., different geographic location) than the user (and thus has temporal metadata values that are not synchronized with the user specific temporal range).

A first data file 615 is illustrated in FIG. 6 as having one or more GPS metadata fields comprising one or more values of longitude/latitude position of 32° 44′ N by 117° 10′ W 612. Accordingly, the correlation component 610 may use this metadata to determine a GMT offset 614 for this data file 615, which is −8:00 hours GMT in the illustrated example. Other data files are similarly illustrated in FIG. 6 with GPS metadata and determined GMT offsets. It will be appreciated that the format of the GPS metadata illustrated in FIG. 6 (e.g., of 32° 44′ N by 117° 10′ W) is merely one example of GPS formatting, and that the correlation component 610 is envisioned as being configured to make use of the GPS metadata regardless of how it is formatted. It will also be appreciated that different geographic or GPS locations may have respective GMT offsets, and that the correlation component 610 may be configured to consult a variety of resources (e.g., databases, tables, internet, local information, GPS satellite, etc.) to determine appropriate GMT offsets.

A calculation component 616 may be configured to determine a date/time alias for the data file 615 based upon the GMT offset determined from the GPS metadata. This alias generally comprises temporal metadata values that are adjusted based upon a determined GMT offset. For example, since the first data file 3234 has a GMT offset of −8:00 and the user specific temporal range has a GMT offset of −5:00 in the illustrated example, the temporal metadata value(s) for this data file are adjusted upwards by 3 hours to 15:31 (from 12:31). Similar adjustments are made to the other data files illustrated in FIG. 6. Note, however that data file 3236 has an initial time of 21:23 on 1/19/09, but that the alias or adjusted date/time for this file is 2:23 on the next day 1/20/09. This is because the GMT offset for this time is −10:00, and thus 5 hours have to be added to this time to synchronize it with the user specific temporal range which has a GMT offset of −5:00 (e.g., 5 hours is added to 21:23 which equals 26:23, or 2:23 on the following day). As will be appreciated, this adjustment or updating causes the 3236 data file to be compiled in an appropriate data set, whereas it would otherwise be (mis)compiled in a different data set (e.g., on the previous day) if the adjustment were not performed.

A compilation component 624 may be configured to compile the data files 617 into appropriate data sets based upon the respective metadata values, as updated by the calculation component 616. A first data set 626 is designated as “01-19-09” in the example illustrated in FIG. 6 as it is named using the beginning date 608 of the user specific temporal range 604. Accordingly, data files that fall within the user specific temporal range 604 of between 13:00 on 1/19/09 and 2:00 on 1/20/09 are compiled within the first data set 626. This comprises data files 3234.JPG and 3235.JPG in the illustrated example since these data files have adjusted time/date aliases of 15:31 on 1/19/09 and 15:45 on 1/19/09, respectively. A second data set 628, named “01-20-09” is likewise illustrated in FIG. 6, and data files that fall outside of the user specific temporal range 604 are compiled within the second data set 628. This comprises data files 3236.JPG and 3237.JPG in the illustrated example since these data files have adjusted time/date aliases of 2:23 on 1/20/09 and 18:23 on 1/20/09, respectively. Note that had the temporal metadata values of data file 3236.JPG not been updated, that data file would have been incorrectly compiled into the first data set 626, instead of the second data set 628 (e.g., because its initial temporal metadata values of 21:23 on 1/19/09 fell within the user specific temporal range 604 of between 13:00 on 1/19/09 and 2:00 on 1/20/09, whereas its updated temporal metadata values of 2:23 on 1/20/09 fall outside of the user specific temporal range 604).

In one example, files within a camera phone configured with GPS metadata tagging capability may be compiled into appropriate data sets based upon GPS metadata. For example, a user may take a variety of photos (e.g., image files) with the camera phone while on a trip around the world. In crossing multiple time zones, the dates and times associated with the image files may become convoluted based upon respective local times zones. For example, the photos may be tagged with a time zone local to the user's place of origin (e.g., a configured setting within the camera), instead of the current time zone in which the user takes the photo. However, GPS metadata data associated with the image files may be utilized to compile the image files for presentation. Upon arriving back to the local time zone GMT, the user may want to compile the image files on the camera phone into an appropriate data set based on a user specific temporal range, for example. In one example, the camera phone compares the image files to the user specific temporal range, correlates a GMT offset with respective image files, calculates a date/time alias relative to a local time zone GMT, and/or compiles the image files within an appropriate data set for presentation. This may allow the user to compile the image files for presentation with respect to the user specific temporal range, where the data files may be adjusted based upon GPS data.

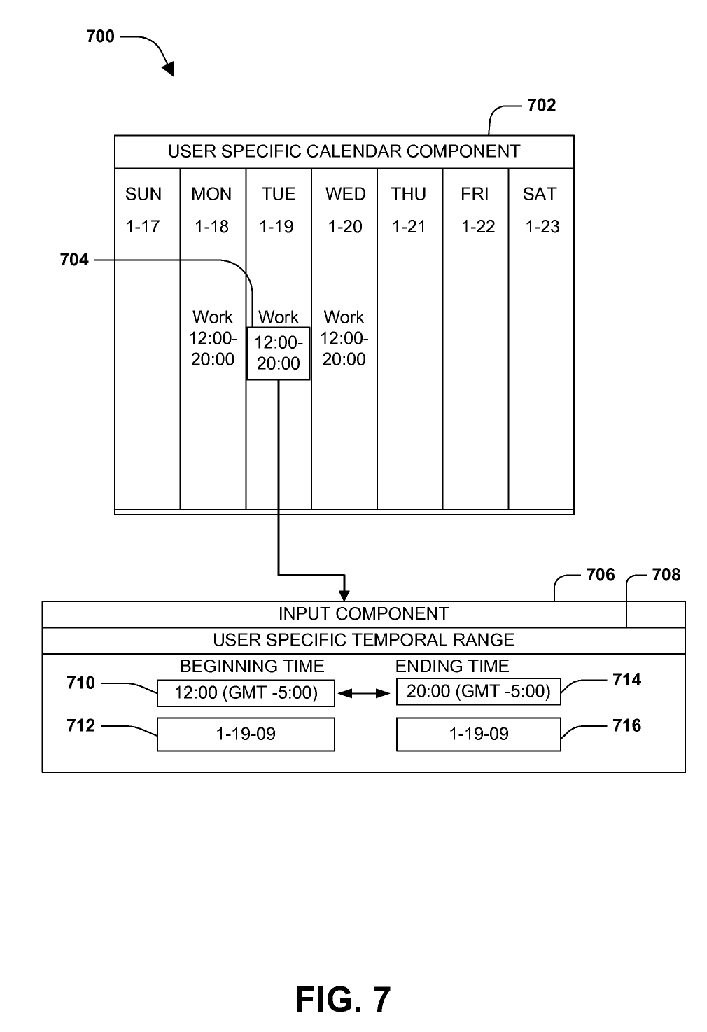

It will be appreciated that rather than requiring a user to manually enter, designate, define, etc. a user specific temporal range, that a more automated technique for accomplishing the same is envisioned. FIG. 7 is an illustration of an example 700 of a user specific temporal range derived from a user specific calendar component 702. It may be appreciated that the user specific temporal range may be derived from one or more of an application default (e.g., to stop at 3 am), an operating system default, and/or other defaults. The user specific calendar component 702 may be derived from one or more devices and/or locations (e.g. online calendar, personal digital assistant (PDA), cell phone, software application, etc.), for example. The user specific calendar component 702 may comprise days/dates and/or one or more temporal ranges respective to days/dates of temporal events. For example, a temporal range 704 illustrates a temporal range related to working hours (e.g., beginning at 12:00 on 1/19/09 and ending on 20:00 on 1/9/09). It will be appreciated that while this temporal range 704 illustrated in FIG. 7 is comprised within a single day, that such temporal ranges may span a plurality of dates or cross over into one or more other dates. The temporal range 704 is then received by input component 706, which is configured to derive a user specific temporal range 708 therefrom. In the illustrated example, the user specific temporal range 708 is defined based upon a beginning time 710, a beginning date 712, an ending time 714, and an ending date 716. It will be appreciated that other data from the user specific calendar component 702 may be accessed and/or otherwise consulted in discerning a user specific temporal range therefrom.

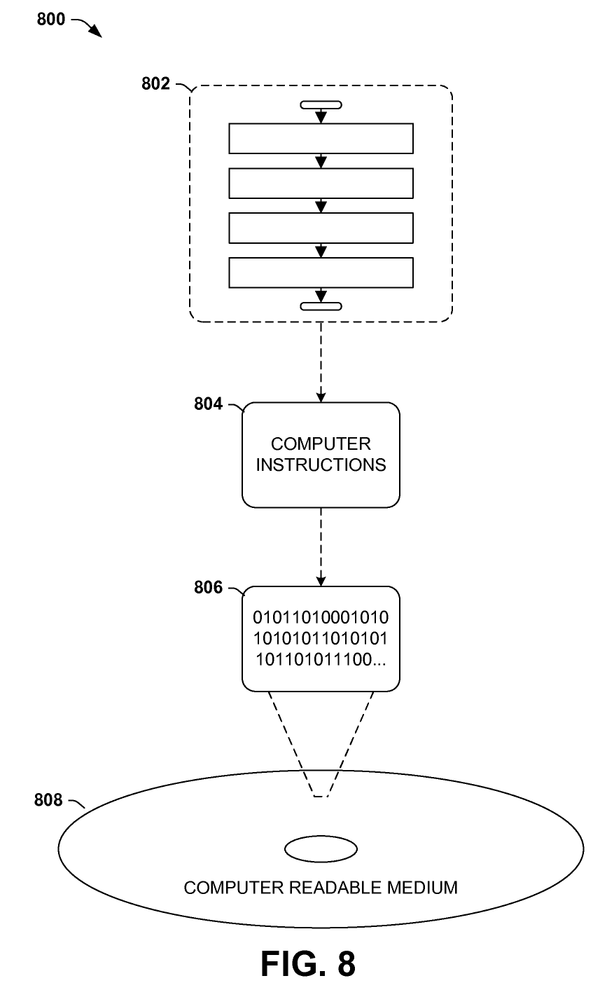

Still another embodiment involves a computer-readable medium comprising processor-executable instructions configured to implement one or more of the techniques presented herein. An exemplary computer-readable medium that may be devised in these ways is illustrated in FIG. 8, wherein the implementation 800 comprises a computer-readable medium 808 (e.g., a CD-R, DVD-R, or a platter of a hard disk drive), on which is encoded computer-readable data 806. This computer-readable data 806 in turn comprises a set of computer instructions 804 configured to operate according to one or more of the principles set forth herein. In one such embodiment, the processor-executable instructions 802 may be configured to perform a method, such as the exemplary method 100 of FIG. 1, for example. In another such embodiment, the processor-executable instructions 802 may be configured to implement a system, such as the data file association system 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

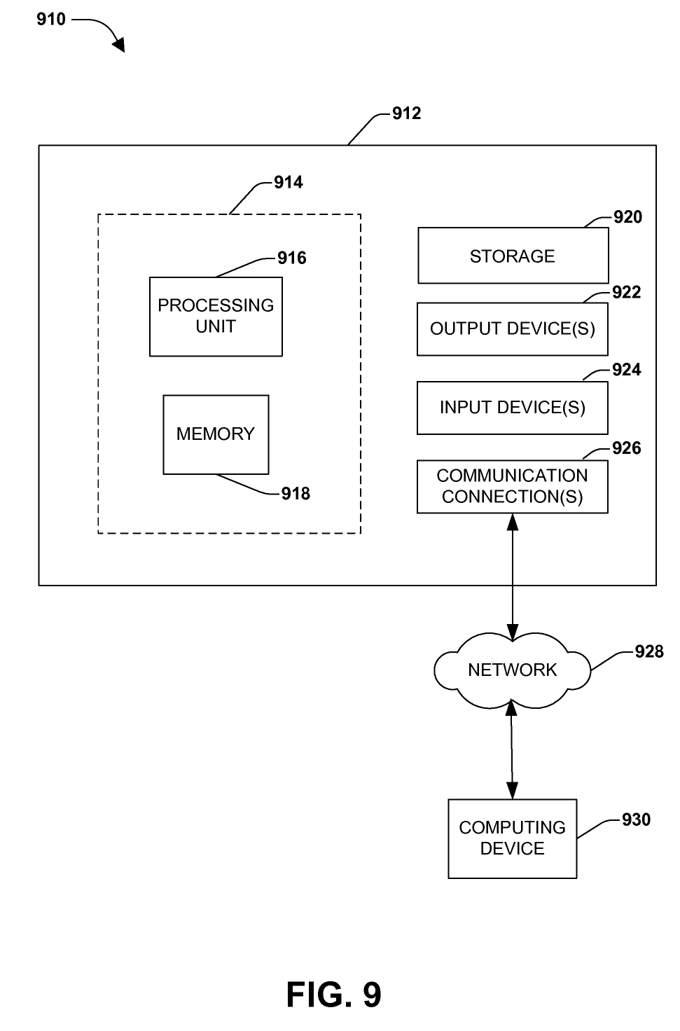

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 910 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for aggregating a data file with respect to a user specific temporal range, comprising:
receiving a user specific temporal range; and
comparing a value within a temporal metadata field of a data file with the user specific temporal range to determine an appropriate data set within which to compile the data file for presentation.

2. The method of claim 1, comprising:
compiling the data file into the appropriate data set for presentation.

3. The method of claim 2, comprising:
presenting the data file within the appropriate data set.

4. The method of claim 1, determining the appropriate data set within which to compile the data file based upon at least one of:
the value falling within the temporal range;
the value being within a proximity of the temporal range; and
the value being one of a predefined number of values within a proximity of the temporal range.

5. The method of claim 1, the user specific temporal range derived from a user specific calendar.

6. The method of claim 1, the data file existing as an image file format, comprising metadata formatted with respect to at least one of:
an exchange image file format (EXIF);
extensible metadata platform (XMP);
Information Interchange Model (IMM); and
a variant of the aforementioned.

7. The method of claim 2, comprising:
presenting one or more data files within the appropriate data set within at least one of:
a user interface;
a web browser; and
a window.

8. The method of claim 2, the appropriate data set named according to a characteristic of the user specific temporal range.

9. The method of claim 2, comprising:
deriving Global Positioning System (GPS) locational metadata from the data file;
correlating a Greenwich Mean Time (GMT) offset with derived GPS locational metadata;
calculating temporal metadata field of a metadata time alias and a
metadata date alias for a respective data file, calculation based upon the GMT offset, a localized GMT, and a metadata created date and a metadata created time; and
the comparing using the temporal metadata field of the metadata time alias and the metadata date alias for a respective data file.

10. The method of claim 7, comprising:
requesting a user affirmation of a validity of an appropriate data set; and
recompile the data files according to the user affirmation.

11. A method for aggregating a data file with respect to a user specific temporal range, comprising:
receiving the user specific temporal range, the user specific temporal range derived from a user specific calendar;
comparing a value within a temporal metadata field of the data file with the user specific temporal range to determine an appropriate data set within which to compile the data file;
deriving Global Positioning System (GPS) locational metadata from the data file;
correlating a Greenwich Mean Time (GMT) offset from derived GPS locational metadata;
calculating temporal metadata fields comprising of a metadata time alias and a metadata date alias, calculation based upon the GMT offset, a localized GMT, and a metadata created date and a metadata created time;
the comparing using the temporal metadata field of the metadata time alias and a metadata date alias for the data file;
compiling the data file into an appropriate data set based upon comparing, the appropriate data set named according to a beginning of the user specific temporal range, the appropriate data set comprising the data file compiled according to a metadata time temporal metadata field falling within the user specific temporal range, and the compiling further based upon at least one of:
the value being within a proximity of the temporal range; and
the value being one of a predefined number of values within a proximity of the temporal range; and
presenting the data file within the appropriate data set within at least one of:
a user interface;
a web browser; and
a window.

12. A system for aggregating a data file with respect to a user specific temporal range, comprising:
an input component configured to receive a user specific temporal range; and
a comparison component configured to compare a value within a temporal metadata field of the data file with the user specific temporal range to determine an appropriate data set within which to compile the data file.

13. The system of claim 12, comprising:
a presentation component configured to present one or more data files within the appropriate data set within at least one of:
a user interface;
a web browser; and
a window.

14. The system of claim 12, comprising:
a derivation component configured to obtain a Global Positioning System (GPS) locational metadata from the data file;
a correlation component configured to correlate a Greenwich Mean Time (GMT) offset with the GPS locational metadata; and
a calculation component configured to calculate a metadata time alias and a metadata data alias, calculation based upon the GMT offset, a localized GMT, and a metadata created data and a metadata created time.

15. The system of claim 12, comprising:
a compilation component configured to compile the data file into the appropriate data set and the appropriate data set labeled according to a characteristic of the user specific temporal range.

16. The system of claim 15, the appropriate data set comprising the data file compiled according to a metadata time belonging within the user specific temporal range.

17. The system of claim 15, the compilation component configured to compile the data file based upon at least one of:
the value falling within the temporal range;
the value being within a proximity of the temporal range; and
the value being one of a predefined number of values within a proximity of the temporal range.

18. The system of claim 17, comprising:
an affirmation component configured to affirm a validity of the appropriate data set; and
the compilation component configured to recompile the data files according to the user affirmation.

19. The system of claim 15, the user specific temporal range is derived from at least one of:
a user specific calendar component;
an application default; and
an operating system default.

20. The system of claim 16, the data file is formatted with respect to at least one of:
an exchange image file format (EXIF);
extensible metadata platform (XMP);
information interchange model (IMM); and
a variant of the aforementioned.
